(19) United States
(12) Patent Application Publication
(10) Pub. No.: US 2009/0300980 A1
(43) Pub. Date: Dec. 10, 2009

(54) CORN WITH TRANSGENIC INSECT PROTECTION TRAITS UTILIZED IN COMBINATION WITH DROUGHT TOLERANCE AND/OR REDUCED INPUTS PARTICULARLY FERTILIZER

(75) Inventors: Gary Thompson, Zionsville, IN (US); Kenneth Narva, Zionsville, IN (US)

Correspondence Address: Baker and Daniels LLP;Suite 2700, 300 N. Meridian Street, Indianapolis, IN, 46204, US

(73) Assignee: Dow AgroSciences LLC, Indianapolis (IN)

(21) Appl. No.: 12/434,384

(22) Filed: May 1, 2009

Related U.S. Application Data
(60) Provisional application No. 61/050,007, filed on May 2, 2008.

(51) Int. Cl. A01G 1/00

(52) U.S. Cl. 47/58.1 FV

(57) ABSTRACT

The subject invention relates in part to the use of insect-protected corn to modify fertility recommendations for given yield targets on any transgenic corn type. The insect-protected plants are unexpectedly more effective at assimilating not only nitrogen but also less valuable nutrients such as phosphorous, potassium and micronutrients such as zinc. The subject invention also relates to the discovery that transgenic corn plants with insect protection traits exhibit drought tolerance. For example, the protected plants are also much more effective at extracting moisture and are therefore more drought resistant and require less supplemental irrigation to produce the same yields as unprotected plants.

### CROSS REFERENCE TO RELATED APPLICATION

This application claims priority to U.S. Provisional Patent Application Ser. No. 61/050,007, filed on May 2, 2008, which is hereby incorporated by reference.

### BACKGROUND OF THE INVENTION

The current fertility recommendations for corn were developed over a long period of time but with traditional nonprotected corn or corn protected with insecticides. Typical current practice is for farmers to over-saturate their fields with fertilizers. This can have negative environmental effects.

Drought tolerance by transgenic corn with insect protection traits was not heretofore known.

### BRIEF SUMMARY OF THE INVENTION

The subject invention relates in part to the use of insect-protected corn to modify fertility recommendations for given yield targets on any transgenic corn type. The insect-protected plants are unexpectedly more effective at assimilating not only nitrogen but also less valuable nutrients such as phosphorous, potassium and micronutrients such as zinc.

The subject invention also relates to the discovery that transgenic corn plants with insect protection traits exhibit drought tolerance. For example, the protected plants are also much more effective at extracting moisture and are therefore more drought resistant and require less supplemental irrigation to produce the same yields as unprotected plants.

### BRIEF DESCRIPTION OF THE DRAWINGS

FIG. 1 illustrates response to rootworm hybrids and insecticide-protected hybrids to reduced rates of nitrogen,

FIG. 2 illustrates rootworm control on yield response to nitrogen.

FIGS. 3 and 4 show results of a study conducted in Illinois involving heavy pressure by soybean variant western rootworm and drought conditions.

FIG. 5A shows plants in an Indiana trial regarding plant protection by Herculex RW with early planting (May) under heavy Western Corn Rootworm pressure under dry conditions.

FIG. 5B shows a far superior root rating for the B.t. plants as compared to non-B.t. plants.

FIG. 5C compares the percent “goosenecking” as discussed in Example 3.

FIGS. 6, 7, and 8 relate to studies conducted under heavy pressure by Western Corn Rootworm in Indiana under dry conditions.

### DETAILED DISCLOSURE OF THE INVENTION

Transgenic corn plants with insect protection traits have been available for several years. There are multiple events for above and below ground insects. These primarily are events that express Bt proteins and are marketed under names such as Herculex, Yieldgard, and Agrisure. They are widely recognized to be efficacious against insect damage and are recommended by Universities and their manufacturers where insect damage is expected. The growing recommendations for all of these insect protected corn plants are identical to nonprotected corn plants.

While insect-protected corn such as Herculex XTRA is currently marketed, methods of using them with reduced fertilizer recommendations was not previously taught or suggested and is a subject of the present invention. Nitrogen inputs are the third most costly input behind land and seed to produce corn, and the cost has increased greatly recently since natural gas is required to produce nitrogen. Thus, the subject invention can also reduce costs for farmers and for consumers.

The subject invention stems in part from our observation that yields of genetically similar corn lines, with and without the insect traits, unexpectedly respond differently to inputs, particularly nitrogen fertilizer. The insect-protected plants have less root damage from below-ground insect feeding. In addition, when damaged by root feeding insects such as corn root worm, the damaged plants regrow quicker and produce a larger root mass and have improved overall plant health. This combination of factors allows the rate of nitrogen and other fertilizers to be reduced to obtain the same amount of yield as non insect-protected corn lines with higher fertility amounts.

The insect-protected plants are unexpectedly more effective at assimilating not only nitrogen but also less valuable nutrients such as phosphorous, potassium and micronutrients such as zinc.

The subject invention also relates to the discovery that transgenic corn plants with insect protection traits exhibit drought tolerance. For example, the protected plants are also much more effective at extracting moisture and are therefore more drought resistant and require less supplemental irrigation to produce the same yields as unprotected plants.

The subject invention can be applied to, for example, corn containing at least one of the following transgenic events: DAS-59122-7, MON 863, MON 88017, and MIR604. Examples of products containing one or more of these events are: Herculex RW (DAS-59122-7), Herculex XTRA (DAS-59122-7), YieldGardRW (MON 863), YieldGard Plus (MON 863) YieldGard VT RW/RR2 (MON88017), YieldGard VT Triple (MON88017), Agrisure RW (MIR604), Agrisure CB/RW (MIR604) and SmartStax (DAS-59122-7×MON 88017).

The B.t. Cry proteins produced by these lines are as follows:

### Herculex RW (Cry34Ab and Cry35Ab)

Herculex XTRA (Cry1F plus Cry34Ab and Cry35Ab)

### YieldGardRW (Cry3Bb)

### YieldGard Plus (Cry1Ab and Cry3Bb)

### YieldGard VT RW/RR2 (Cry3Bb)

### YieldGard VT Triple (Cry3Bb)

### Agrisure RW (Cry3A),

### Agrisure CB/RW (Cry1Ab)

### SmartStax (Cry1F, Cry34Ab/35Ab, Cry1A.105, Cry2Ab, and Cry3Bb)

Other approaches include RNAi-mediated WCR resistance. For example,

transgenic plants can comprise a dsRNA for suppression of an essential gene in a corn rootworm; such plants can be used according to the subject invention. Vacuolar ATPase and other target genes described in WO2007/035650, for example, can also be used according to the subject invention.

Application rates (for fertilizer and/or the like) can be determined from the subject disclosure. Some particular application rates and amounts, included within the subject invention, are shown in the Figures and are provided below in the Sample Claims. Some preferred embodiments are also further specified in the Sample Claims.

All patents, patent applications, provisional applications, and publications referred to or cited herein are incorporated by reference in their entirety, including all figures and tables, to the extent they are not inconsistent with the explicit teachings of this specification.

Unless specifically indicated or implied, the terms “a”, “an”, and “the” signify “at least one” as used herein.

Following are examples which illustrate procedures for practicing the invention. These examples should not be construed as limiting. All percentages are by weight and all solvent mixture proportions are by volume unless otherwise noted.

### Example 1

### Reduced Nutrient Requirements

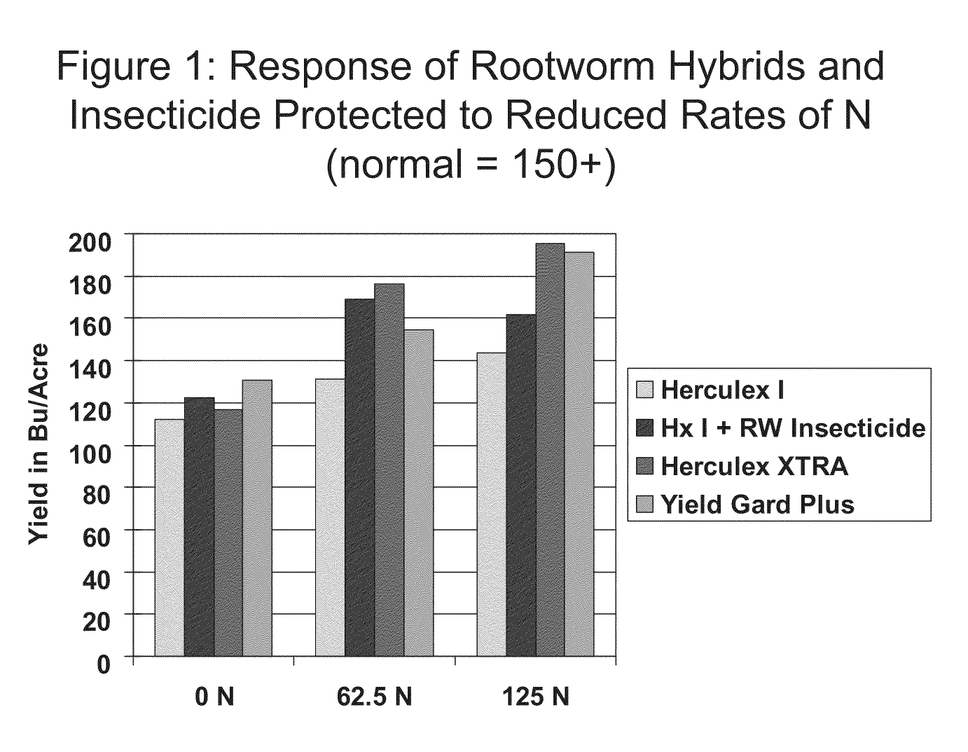

FIG. 1 relates to a trial conducted in Nebraska Herculex XTRA includes the cry34/cry34 rootworm control genes, as well as the cry1F gene (for protecting the corn ear). FIG. 1 shows that rootworm control methods result in higher yields at N rates below the normal cropping practice of about 150 pounds per acre. It also shows that transgenic rootworm control is superior to chemical insecticides. In addition, it shows that the increased yield is not due to the Cry1F/lepidopteran-control component in Herculex XTRA. Herculex 1 (containing only the cry1F gene—not the cry34/cry35 genes) thus serves as the control to make this point.

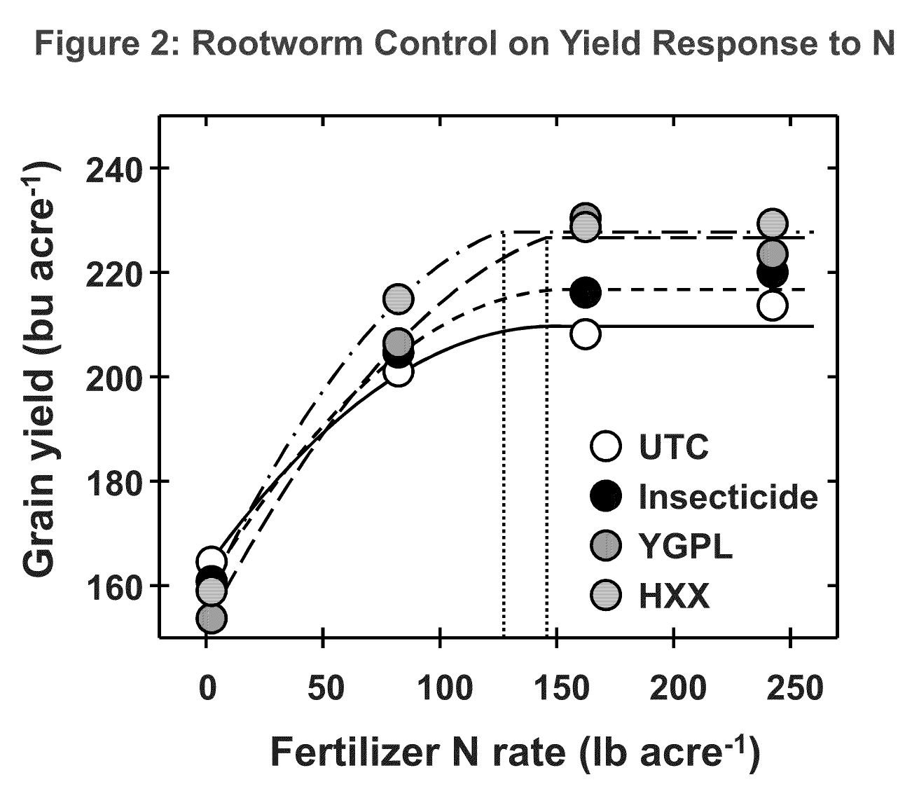

As illustrated by FIG. 2, in this study the Herculex XTRA hybrid was higher yielding at lower N rates than the other lines.

### Example 2

### Illinois Drought Resistance Study—Year 1

Studies were conducted in Pesotum (Douglas County), Ill., which was “ground zero” for Soybean Variant Western Rootworm (WCRW). Heavy rootworm pressure and drought conditions in June & July were experienced.

Control plots (Force® 3G, Seed Traits) and untreated plots were all drought stressed. Their leaves were curled and grayish-green—exhibiting severe stress, and growth had stopped.

HERCULEX RW plants were green with leaves unfurled and were growing well in dry conditions.

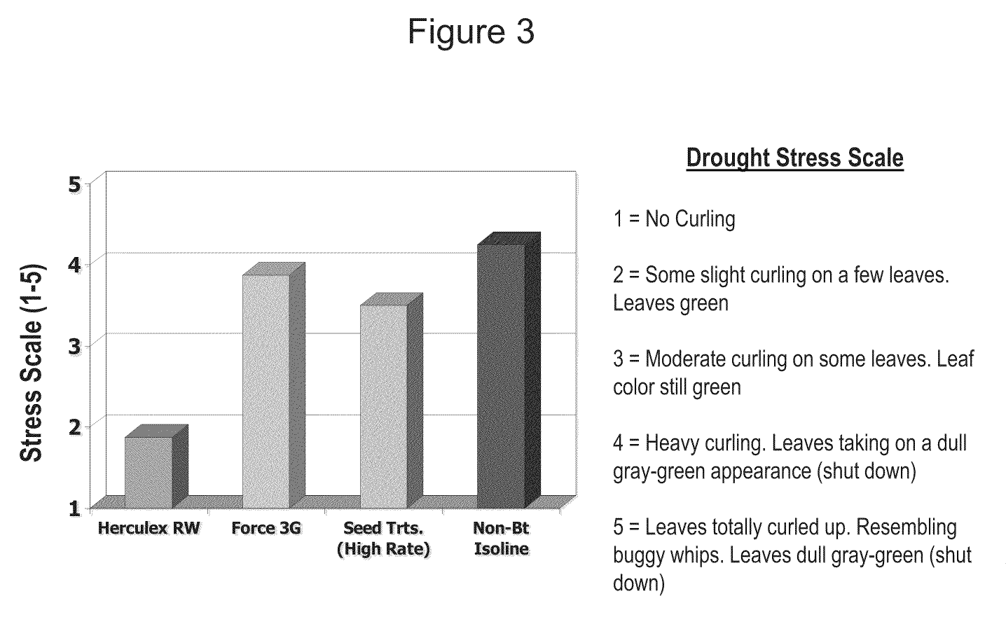

As shown in FIG. 3, Herculex RW grew well under dry conditions. All other treatments showed significant drought stress.

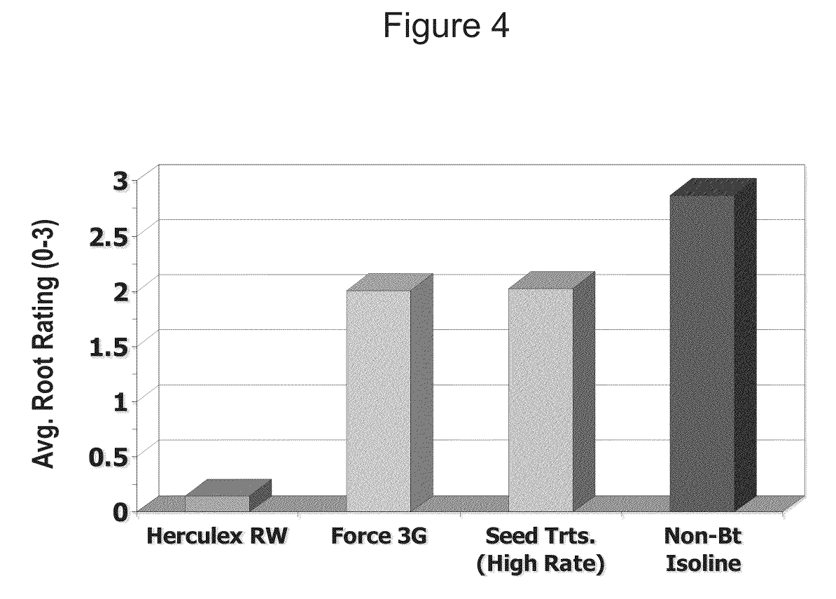

FIG. 4 shows efficacy of Herculex RW against Soybean Variant WCRW. As shown in FIG. 4, Herculex RW provided significantly better protection than all other treatments (LSD, p≦0.05).

Findings and conclusions:
Rootworm pressure varied from low to high depending on location
Root protection by Herculex RW was unsurpassed by other control strategies.
Under drought conditions, Herculex RW hybrids showed significantly less plant stress than hybrids protected by conventional treatments.

### Example 3

### Resistance to Dry Conditions in Indiana—Year 1

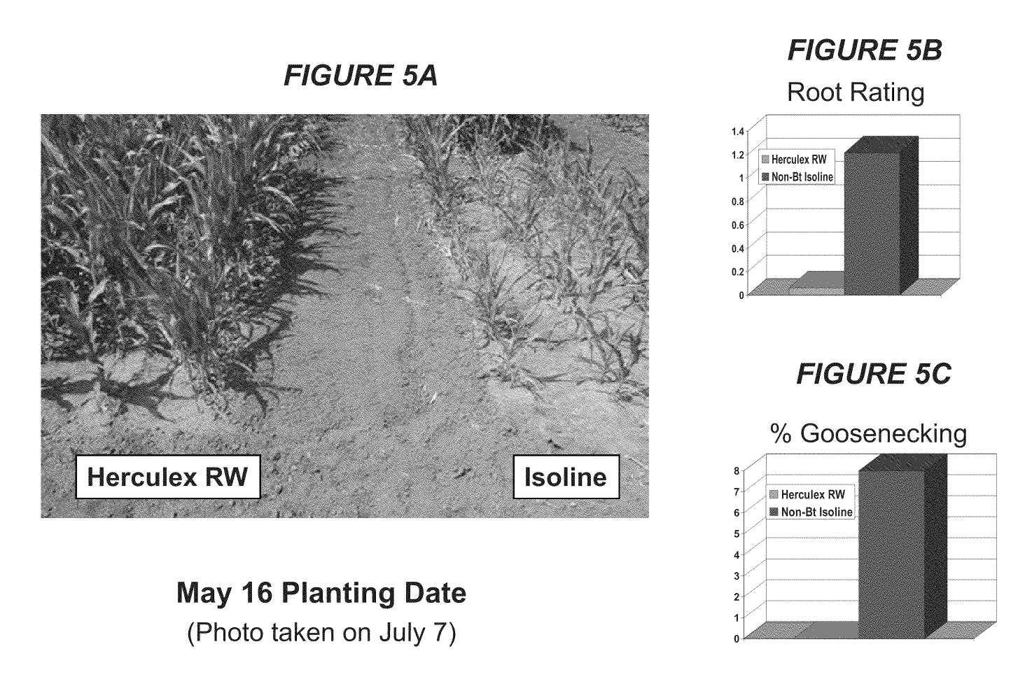

This Example relates to a trial in Fowler, Ind., regarding plant protection by Herculex RW with early planting (May) under heavy Western Corn Rootworm pressure under dry conditions in year 1. See FIGS. 5A, 5B, and 5C. FIG. 5C shows “gooseneck” rating. (When plants lean due to insufficient root mass then try to right themselves, they end up with a curved stalk. Under certain conditions, plants may fall over and lodge on the ground due to rootworm feeding damage. Lodged and misshapen plants often pollinate poorly and can slow harvest.) Conclusions:
CRW pressure is more severe when corn is planted early April to early May.
   Larvae are attracted to larger, newly developing root nodes, e.g., third node roots.
Herculex RW provided highly significant root protection under early planting and heavy rootworm pressure.
   Herculex RW plants did not show symptoms of water stress or root lodging as did their non-Bt isogenic comparisons.
   Even when moderate surface feeding was observed on Herculex RW roots, plants did not show adverse above-ground symptoms (e.g., leaf curling, stunting, lodging).

### Example 4

### Resistance to Drought Conditions in Indiana—Year 3

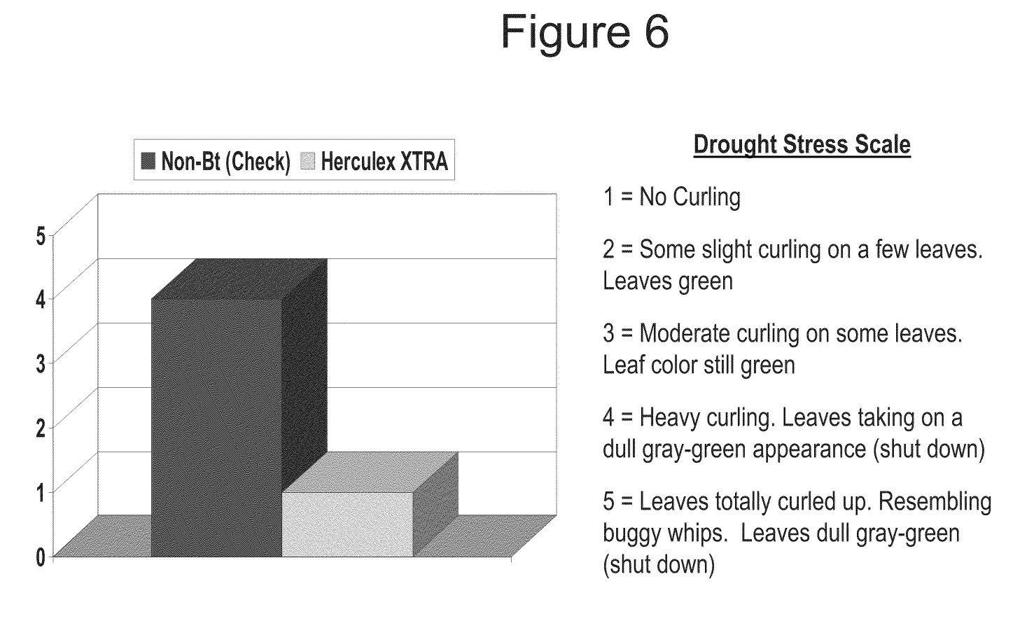

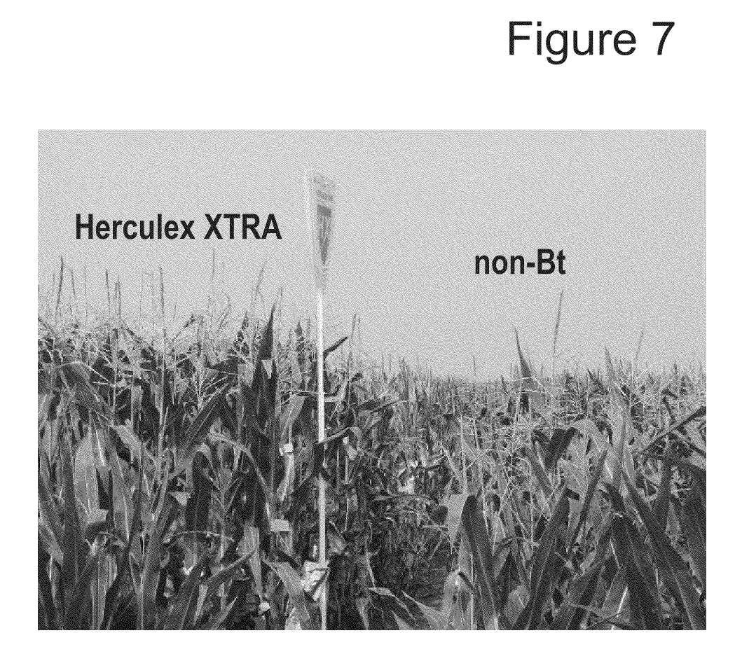

For FIGS. 6 and 7, small plot studies were conducted in year 3 under heavy pressure by Western Corn Rootworm in Fowler, Ind., under dry conditions. As shown in FIG. 7, Herculex XTRA corn was taller and showed less drought stress than non-BT corn.

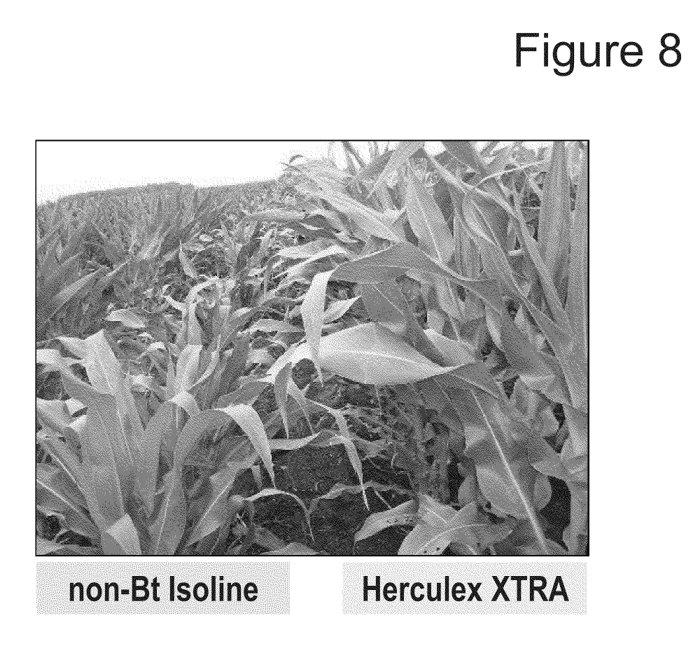

In a breeding field trial conducted at the same location and year, and for the growth of the plants shown in FIG. 8, drought stress conditions occurred around V5 to V7. The picture is post rainfall, but shows dramatic effects of how XTRA material stayed healthy and kept extending, while the isolines had already suffered reduced growth.

We claim:

1. A method of growing transgenic corn plants by using a reduced amount of fertilizer, wherein the transgenic corn is insect resistant due to expression of an insect-resistance gene, and wherein the reduced amount of fertilizer is relative to fertilizer recommended for use on non-transgenic corn, wherein said non-transgenic corn is optionally protected by granular chemical insecticide to control rootworms.

2. The method of claim 1 wherein said transgenic corn plants yield corn comparable to corn yield from said non-transgenic corn grown using said recommended amounts of fertilizer.

3. The method of claim 1 wherein said transgenic corn contains at least one of the following transgenic events: DAS-59122-7, MON 863, MON 88017, and MIR604.

4. The method of claim 1 wherein said fertilizer is applied to said transgenic corn plants at a corresponding rate and/or amount as illustrated in FIG. 1 and/or FIG. 2.

5. The method of claim 1 wherein said fertilizer is selected from the group consisting of a nitrogenous fertilizer, a phosphorous fertilizer, a potassium fertilizer, and a micronutrient fertilizer such as zinc.

6. The method of claim 1 wherein said transgenic plant comprises a Bacillus thuringiensis insect-resistance gene.

7. The method of claim 6 wherein said Bacillus thuringiensis insect-resistance gene encodes a Cry protein.

8. The method of claim 6 wherein said insect-resistance gene is selected from the group consisting of a cry34 gene, a cry35 gene, a cry3Bb1 gene, and a cry3A gene.

9. The method of claim 1 wherein said transgenic plant comprises a dsRNA for suppression of a corn rootworm gene in a corn rootworm, which could include a vacuolar ATPase.

10. The method of claim 5 wherein said nitrogenous fertilizer is applied at a rate range selected from the group consisting of less than 150 pounds per acre, less than 125 pounds per acre, less than 100 pounds per acre, less than 75 pounds per acre, and at least 50 pounds per acre.

11. The method of claim 9 wherein said transgenic corn plants are being grown on a field where other corn was grown in the preceding season.

12. The method of claim 11 wherein said transgenic corn plants are being grown on a field where soybeans were grown in the preceding season.

13. The method of claim 1 wherein said nitrogenous fertilizer is applied to cover a field of a size selected from the group consisting at least 1 acre, at least 5 acres, at least 10 acres, and at least 399 acres.

14. The method of claim 7 wherein said Cry protein is active and/or used to control corn rootworms.

15. The method of claim 1 wherein said transgenic corn plants are grown in a field, and said fertilizer is nitrogenous fertilizer applied to said field prior to planting said corn plants.

16. The method of claim 1 wherein said transgenic corn plants are grown in a field, and said fertilizer is nitrogenous fertilizer applied to said field after planting said corn plants in said field but prior to emergence.

17. The method of claim 1 wherein said transgenic corn plants are grown in a field, and said fertilizer is nitrogenous fertilizer applied to said field when said plants are growing in said field.

18. The method of claim 1 wherein said nitrogenous fertilizer is applied prior to emergence and also applied to said field in the fall.

19. The method of claim 14 wherein said gene is expressed in the roots of said plants.

20. The method of claim 1 wherein said transgenic plants have a yield selected from the group consisting of at least 200 bushels of grain per acre, at least 210 bushels of grain per acre, and at least 220 bushels of grain per acre.

21. The method of claim 18 wherein said fertilizer is applied after harvest and before freeze.

22. A method of growing transgenic corn plants by using a reduced amount of supplemental irrigation to produce the same yields as unprotected plants, wherein the transgenic corn is insect resistant due to expression of an insect-resistance gene, and wherein the reduced amount of irrigation is relative to irrigation used on non-transgenic corn, wherein said non-transgenic corn is optionally protected by granular chemical insecticide to control rootworms.

23. A method of producing drought-resistant corn plants in an area that is inhospitable to non-drought-resistant corn plants, said method comprising planting seeds in said area, wherein said seeds produce transgenic corn plants that are insect-resistant due to expression of an insect-resistance gene.

24. The method of claim 1, wherein said non-transgenic corn is non-transgenic corn in an adjacent refuge required by regulatory requirements to grow said transgenic corn.

25. The method of claim 22, wherein said non-transgenic corn is non-transgenic corn in an adjacent refuge required by regulatory requirements to grow said transgenic corn.
